(19) United States
(12) Patent Application Publication
(10) Pub. No.: US 2015/0147978 A1
(43) Pub. Date: May 28, 2015

(54) MILLIMETER WAVE WIRELESS COMMUNICATION BETWEEN COMPUTING SYSTEM AND DOCKING STATION

(71) Applicant: Lenovo (Singapore) Pte. Ltd., New Tech Park (SG)

(72) Inventors: Mark Charles Davis, Durham, NC (US); Howard Jeffrey Locker, Cary, NC (US)

(73) Assignee: Lenovo (Singapore) Pte. Ltd., New Tech Park (SG)

(21) Appl. No.: 14/092,265

(22) Filed: Nov. 27, 2013

(51) Int. Cl. H04B 1/38; G06F 1/16; H04B 1/40

(52) U.S. Cl. CPC H04B 1/3827; H04B 1/40; G06F 1/1632
USPC 455/73

(57) ABSTRACT

A system includes at least one computer, at least one dock which engages the computer, and at least first and second millimeter wave transceivers which transmit information between the computer and the dock. The first transceiver sends signals having a first polarization and the second transceiver sends signals having a second polarization different from the first polarization.

### FIELD

The present application relates generally to wireless communication between computing systems and docking stations using millimeter wave transceivers.

### BACKGROUND

Computing systems such as notebook computers are often configured to communicate with a docking station providing additional functionality for the computing system and/or enhancing one or more functions of the computing system, such as e.g. providing additional processors and graphics cards for additional processing power. However, communications between a computing system and docking station often require a relatively high amount of bandwidth that heretofore has not been adequately provided by current systems owing to many factors including the cumbersome and/or fragile nature of such systems, as well as a relatively small amount of available physical space on the computers and docking stations which may be used for providing various means of increasing bandwidth in such systems.

### SUMMARY

Accordingly, in a first aspect a system includes at least one computer, at least one dock engages the computer, and at least first and second millimeter wave transceivers transmit information between the computer and the dock. The first transceiver sends signals having a first polarization and the second transceiver sends signals having a second polarization orthogonal to the first polarization. In addition to the foregoing, in some embodiments the first and second millimeter wave transceivers may send and receive signals in a band comprising at least 57 GHz to 64 GHz, and may be wireless gigabit (WiGig) transceivers.

In some embodiments, the first transceiver may be on the dock and the second transceiver may be on the computer. In others, both the first and second transceivers may be on the dock and may communicate with at least one transceiver on the computer. In still other embodiments, both the first and second transceivers may be on the computer and may communicate with at least one transceiver on the dock.

In any case, it is to be understood that the first and second transceivers may nonetheless be oriented on the dock orthogonal to each other to at least in part establish the respective first and second polarizations, and/or respective antennas on the first and second transceivers may be oriented orthogonal to each other to at least in part establish the respective first and second polarizations. In addition to or in lieu of what is disclosed in the foregoing sentence, filters, reflectors, and/or refractors on the transceivers may establish the first and second polarizations.

In another aspect, a method includes sending information from a computer to a docking station using a wireless 60 gHz transmitter, and receiving the information at the docking station using a 60 gHz receiver.

In still another aspect, a system includes at least a first computing component which wirelessly communicates with at least a second computing component. The system also includes at least first and second wireless gigabit (WiGig) transceivers which transmit information between the first and second components, where the first transceiver sends signals having a first polarization and the second transceiver sends signals having a second polarization at least substantially orthogonal to the first polarization.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of a system including a docking station and computer in accordance with present principles;

FIG. 2 is a block diagram of a computer in accordance with present principles; and

FIGS. 3-6 are additional block diagrams of a docking station and a computer with varying numbers of millimeter wave transceivers in accordance with present principles.

### DETAILED DESCRIPTION OF THE PREFERRED EMBODIMENT

This disclosure relates generally to consumer electronics (CE) device based and/or workstation based user information. With respect to any computer systems discussed herein, a system may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones. These client devices may employ, as non-limiting examples, operating systems from Apple, Google, or Microsoft. A Unix operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the CE device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term“circuit” or“circuitry” is used in the summary, description, and/or claims. As is well known in the art, the term“circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

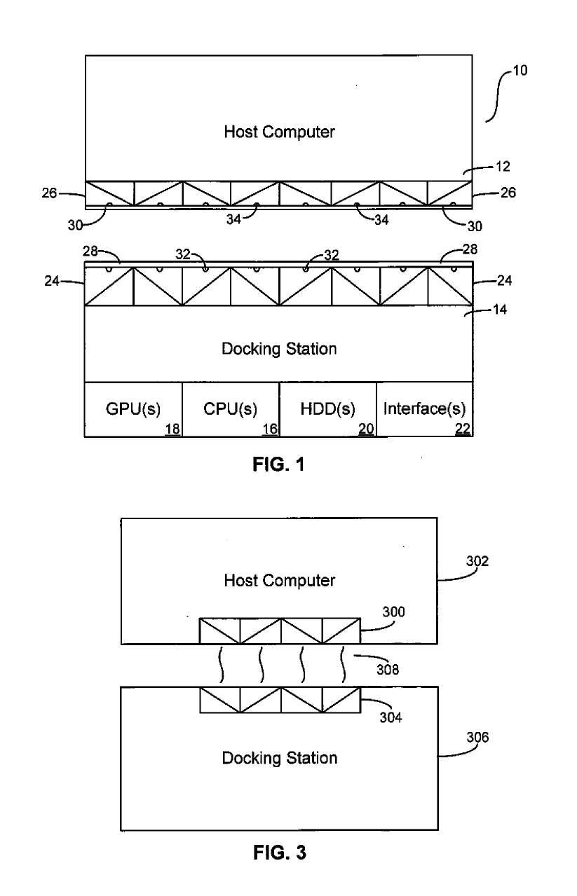

Now in reference to FIG. 1, an exemplary system 10 is shown, which includes a host computer 12 and a computing function extending apparatus 14 that in exemplary embodiments is a docking station. The docking station 14 may include one or more central processing units 16 and one or more graphics processing units (GPUs) 18, as well as e.g. a hard disk drive (HDD) 20 that may not be a carrier wave and/or one or more interfaces 22 such as e.g. USB interfaces for communicatively connecting the docking station 14 to e.g. a keyboard, display, speakers, etc.

In addition to the foregoing, the docking station 14 may also include one or more wireless millimeter wave transceivers 24 configured for communication with wireless millimeter wave transceivers 26 on the computer 12. It is to be understood that the wireless millimeter wave transceivers 24 and 26 may be wireless gigabit (WiGig) transceivers configured for sending and receiving signals in the frequency band of twelve to eighty six gigahertz (GHz), and more particularly in example embodiments the band of fifty seven to seventy gigahertz, and even more particularly fifty seven to sixty four gigahertz, and even more particularly in example embodiments is configured for sending and receiving signals at or substantially proximate to sixty gigahertz (e.g. fifty nine gigahertz to sixty one gigahertz).

Further describing the millimeter wave transceivers 24 and 26, it is to be understood that one transceiver 24 and one transceiver 26 may together establish a transceiver channel and/or lane for communication therebetween. Thus, as may be appreciated from FIG. 1, each of the exemplary eight transceivers 24 of the docking station 14 are configured for communication with at least one respective transceiver 26 of eight transceivers 26 on the computer 12 to thereby establish eight respective communication lanes and/or channels. For instance, the left-most transceiver 24 as shown on FIG. 1 may communicate with the left-most transceiver 26 to establish a communication lane.

Furthermore, it is to be understood that e.g. adjacent transceivers 24 may be configured to transmit signals with different polarizations, and likewise adjacent transceivers 26 may be configured to transmit signals with different polarizations. For example, in some exemplary embodiments two adjacent transceivers 24 may be oriented orthogonal to or at least substantially orthogonal (e.g. eighty to one hundred degrees) to each other (e.g. along a frontal plane of the transceivers 24 facing transceivers 26 for communication therewith). Likewise, two adjacent transceivers 26 may be oriented orthogonal to or at least substantially orthogonal (e.g. eighty to one hundred degrees) to each other (e.g. along a frontal plane of the transceivers 26 facing transceivers 24 for communication therewith). Thus, and as may be appreciated from the illustrative diagonal lines alternating on the transceivers 24 and also the transceivers 26, every other transceiver on either or both of the computer 12 and docking station 14 may transmit signals with the same polarization, with transceivers therebetween transmitting signals at an polarization orthogonal thereto. Furthermore, it is to be understood that a transceiver 24 and a transceiver 26 establishing a communication lane and/or channel may transmit and receive signals of the same polarization even if an adjacent transceiver pair establishing another lane transmits and receives signals of a different polarization.

Accordingly, in example embodiments the transceivers 24 may be spaced mere millimeters apart from each other on the docking station 14 such as e.g. two millimeters apart, or may even be e.g. adjacent to each other and even physically abutting each other, but owing to any given millimeter wave transceiver 24 transmitting signals having a polarization different from other millimeter wave transceivers on either side thereof as shown in FIG. 1, little to no signal interference or crosstalk may occur between signals from any two adjacent communication lanes established by a dock transceiver/computer transceiver pair. The foregoing applies to the spacing and/or orientation of the transceivers 26 on the host computer 12 as well.

Notwithstanding, note that in other embodiments each of the transceivers 24 on the docking station 14 may transmit signals at polarizations different from each other (i.e. each transceiver 24 is configured to transmit signals with a polarization not used by any other transceiver 24). Likewise, each of the transceivers 26 on the computer 12 may transmit signals with polarizations different from each other (i.e. each transceiver 26 is configured to transmit signals with a polarization not used by any other transceiver 26) but nonetheless may transmit and receive signals having the same polarization as e.g. a respective transceiver 24 on the docking station 14 with which the respective transceiver 26 is configured to communicate with and even e.g. which together establish a lane and/or channel.

In still other embodiments, transceivers 24 may be arranged such that each one is oriented e.g. forty five degrees different from an adjacent transceiver 24. Thus, for instance, a left-most transceiver 24 may be oriented at a first orientation, a second transceiver 24 immediately to the right of the transceiver 24 may be oriented forty five degrees different from the left-most transceiver (e.g. relative to and/or along a plane established by transceiving ends of the transceivers 24), and a third transceiver may be oriented forty five degrees different from the second transceiver 24 and hence ninety degrees different from the first transceiver 24. Still other transceivers 24 in a sequence of transceivers 24 may be oriented forty five degrees different from each other, e.g. left to right. The foregoing disclosure in the present paragraph can be equally applied to the transceivers 26 as well.

In addition to or in lieu of orienting transceivers differently from each other on either the computer 12 or docking station 14 as set forth above, each respective transceiver 24 may in some embodiments include a polarization element 28 associated therewith, adjacent thereto, and/or mechanically engaged therewith for polarizing a signal from the respective transceiver 24. Likewise, each respective transceiver 26 may in some embodiments include a polarization element 30 associated therewith, adjacent thereto, and/or mechanically engaged therewith for polarizing a signal from the respective transceiver 26.

Thus, the polarization elements 28 and 30 may be e.g. filters, reflectors, and/or refractors that may at least in part establish the polarizations of signals from respective transceivers associated with the elements 28, 30. Furthermore, note that any combination of filters, reflectors, and/or refractors may together establish an element 28 and/or 30 and thus be associated with a single respective transceiver 24, 26. Further still, in some embodiments configuration of the elements 28 may vary between respective transceivers 24 and the elements 30 may vary between respective transceivers 26. For example, a first of the transceivers 24 may have a filtering element 28 while a second of the transceivers 24 may have a refracting element 28.

Notwithstanding the foregoing description of the elements 28, 30, it is to be nonetheless understood that the configuration of the transceivers 24 relative to each other (e.g. orthogonal thereto) may (e.g. by itself) establish a configuration of transceivers transmitting and receiving signals with differing polarizations. What's more, it is to be understood that in addition to or in lieu of the transceivers 24 being oriented differently from each other (e.g. orthogonal thereto) to thus transmit signals of differing polarizations, it is to be understood that respective antennas 32 on the transceivers 24 may be oriented differently (e.g. orthogonal) from antennas on adjacent transceivers 24 to thus configure the transceivers 24 for transmitting and receiving signals with different polarizations than adjacent transceivers 24, and likewise respective antennas 34 on the transceivers 26 may be oriented differently (e.g. orthogonal) from antennas on adjacent transceivers 26 to thus configure the transceivers 26 or transmitting and receiving signals with different polarizations than adjacent transceivers 26.

Though not specifically shown on the docking station 14 of FIG. 1, it is to be understood that the docking station 14 and indeed any docking station in accordance with present principles may further include one or more of a power source for providing power to the computer 12, visual alignment indicators for aligning the docking station 14 with the host computer 12 and indeed aligning the transceivers 24 with respective transceivers 26 to thereby establish respective lanes in accordance with present principles, a display port (e.g. VGA) for connecting a display to the docking station 14, additional ports such as e.g. USB ports (e.g. USB 2.0 and/or 3.0) for connecting the docking station 14 to other peripheral components such as e.g. a printer, video ports, audio ports, network (e.g. Ethernet) ports, etc. Furthermore, a docking station in accordance with present principles may include an interlock mechanism for mechanically engaging with a computer, and in such embodiments e.g. the dock and/or computer may be configured to not transmit signals using the wireless millimeter transceivers unless a signal indicative of interlock of the devices is received by a processor of the respective device, thereby eliminating emissions from the transceivers unless the two devices are engaged with each other and also conserving power and/or battery life.

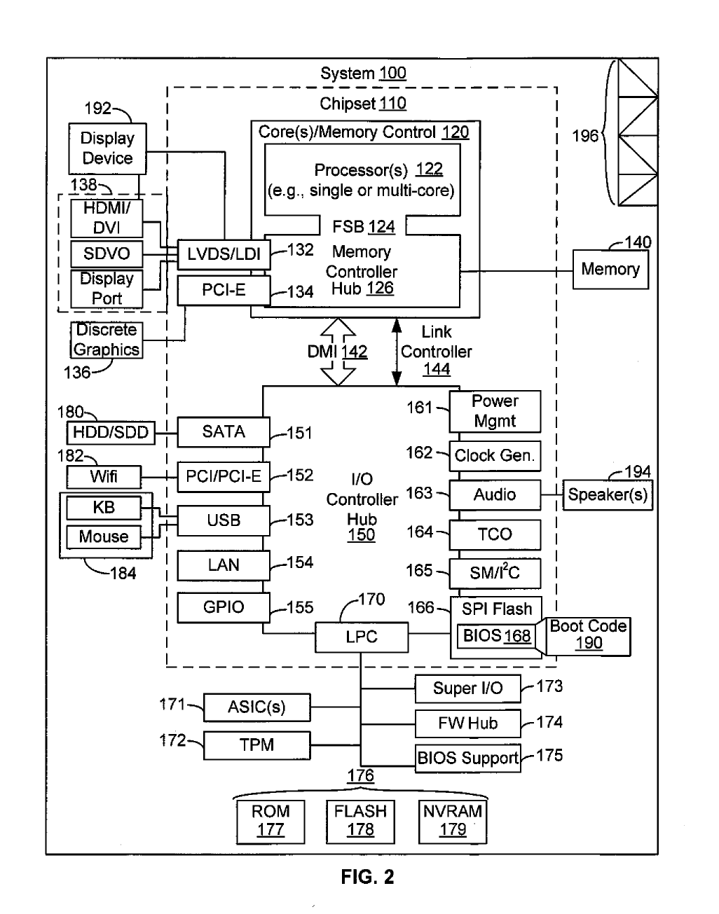

Turning to FIG. 2, it shows an exemplary block diagram of a computer system 100 (e.g. a host computer such as the computer 12 discussed above). The system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine may include other features or only some of the features of the system 100.

As shown in FIG. 2, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 2, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 2, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional“northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as“system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including e.g. one of more GPUs). An exemplary system may include AGP or PCI-E for support of graphics.

The I/O hub controller 150 includes a variety of interfaces. The example of FIG. 2 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 2, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 2, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168. Again, as described herein, an exemplary client device or other machine may include fewer or more features than shown in the system 100 of FIG. 2, but is nonetheless understood to include at least one WiGig transceiver 196 and may even include e.g. four WiGig transceivers 196 as shown in FIG. 2, where any two adjacent transceivers 196 are oriented ninety degrees different from each other along e.g. a plane established by a housing of the system 100 (e.g. a side wall of the housing of the system 100).

In any case, and before moving on to FIG. 3, it is to be understood at least based on the foregoing that the system 100 is configured to undertake present principles (e.g. communicate with other CE devices using respective WiGig transceivers to undertake present principles, execute the logic described below, and/or perform any other functions and/or operations described herein).

Now in reference to FIG. 3, an exemplary host computer and docking station system is shown, this time with four millimeter wave WiGig transceivers 300 on a host computer 302 that may be substantially similar in function and configuration to the computers 12 and 100 described above (e.g. save for the differing number of WiGig transceivers). FIG. 3 also shows four millimeter wave WiGig transceivers 304 on a docking station 306 that may be substantially similar in function and configuration to the docking station 14 described above (e.g. save for the differing number of WiGig transceivers). Illustrative transmission lines 308 are also shown and are understood to represent respective communication lanes between one of the transceivers 300 and one of the transceivers 304. Also note that e.g. any two adjacent transceivers 300 or transceivers 304 may transmit signals having polarizations that are orthogonal to each other in accordance with present principles. In other words, the left-most transceiver 300 may transmit with a first polarization, the transceiver 300 that is immediately to the right of the left-most transceiver (the transceiver second from the left) may transmit with a polarization that is orthogonal to that of the left-most transceiver. The transceiver 300 third from the left may transmit at a polarization that is orthogonal to that of the transceiver second from the left, and the right-most transceiver may transmit at a polarization that is orthogonal to that of the third from the left transceiver. When antennas on each transceiver are used to establish polarization, it is to be understood that for purposes of the discussion immediately preceding that the antenna is considered to be part of the transceiver. It may be appreciated from FIG. 3 that the four transceivers 300 and four transceivers 304 establishing four respective communications lanes may thus constitute a relatively “low-end” workstation system.

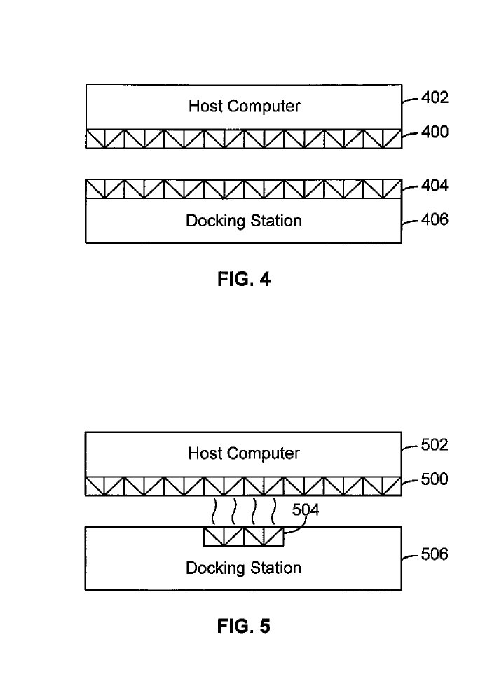

Turning now to FIG. 4, an exemplary host computer and docking station system is shown, this time with sixteen millimeter wave WiGig transceivers 400 on a host computer 402 that may be substantially similar in function and configuration to the computers described above (e.g. save for the differing number of WiGig transceivers). FIG. 4 also shows sixteen millimeter wave WiGig transceivers 404 on a docking station 406 that may be substantially similar in function and configuration to the docking stations described above (e.g. save for the differing number of WiGig transceivers). Thus, it is to be understood that a first computer WiGig transceiver 400 may be aligned (e.g. within a margin of error or one to two millimeters) to communicate with a first docking station WiGig transceiver 404 to establish a communication lane. Each of the other fifteen WiGig transceivers 400 may be respectively aligned with one of the other fifteen WiGig transceivers 404 to establish additional lanes though not all lanes need necessarily be used at a given time and indeed may vary depending on the amount of bandwidth required for communication between the host computer 402 and docking station 406 at a given time. It is to also be understood that any two transceivers 400 adjacent to each other, and likewise any two transceivers 404 adjacent to each other, may be configured to transmit signals having polarizations that are orthogonal to each other in accordance with present principles. Thus, it may be appreciated from FIG. 4 that the sixteen transceivers 400 and sixteen transceivers 404 establishing sixteen respective communications lanes may thus constitute a relatively high-end workstation system.

Continuing the detailed description in reference to FIG. 5, an exemplary host computer and docking station system is shown, this time with sixteen millimeter wave WiGig transceivers 500 on a host computer 502 that may be substantially similar in function and configuration to the computers described above (e.g. save for the differing number of WiGig transceivers). FIG. 5 also shows four millimeter wave WiGig transceivers 504 on a docking station 506 that may be substantially similar in function and configuration to the docking stations described above (e.g. save for the differing number of WiGig transceivers).

As may be appreciated from FIG. 5, only four of the sixteen WiGig transceivers 500 are aligned with the four WiGig transceivers 504 for communication therebetween. Thus, it is to be understood that docking stations and host computer in accordance with present principles need not necessarily both have the same number of WiGig transceivers for communication therebetween, but that e.g. at least one WiGig communication lane may nonetheless be established when at least one WiGig transceiver is present on both of the host computer and docking station. Accordingly, in the example shown in FIG. 5, four millimeter wireless communication lanes may be established for a docking station with four transceivers 504 even where a host computer has more than four transceivers 500. The opposite may be true though not shown in that e.g. a host computer may have less transceivers than a docking station but nonetheless at least as many communication lanes may be established as there are transceivers on the host computer. Note further that signals being transmitted over adjacent lanes as shown are understood to have different polarizations in accordance with present principles.

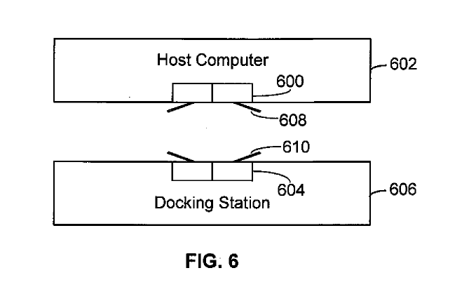

Now in reference to FIG. 6, yet another exemplary host computer and docking station system is shown, this time with two millimeter wave WiGig transceivers 600 on a host computer 602 that may be substantially similar in function and configuration to the computers described above (e.g. save for the differing number of WiGig transceivers). FIG. 6 also shows two millimeter wave WiGig transceivers 604 on a docking station 606 that may be substantially similar in function and configuration to the docking stations described above (e.g. save for the differing number of WiGig transceivers). Note further that as shown in FIG. 6, each transceiver 600 and transceiver 604 is shown with an exemplary antenna 608 or 610, respectively, for transmitting and receiving polarized millimeter wave wireless signals. Also note that the exemplary figure also shows the two antennas 608 oriented orthogonal to each other (e.g. in at least one plane). Likewise, note that the two antennas 610 are also oriented orthogonal to each other (e.g. in at least one plane) but are nonetheless understood to be configured to send and receive signals from a respective antenna 608 with which each a given antenna 610 is aligned, and thus each of the two exemplary lanes that may be established may be for transmission of signals having differing and e.g. substantially orthogonal polarizations. Concluding the description of FIG. 6, it is to be understood that more or less transceivers 602 and 604 with respective antennas in accordance with present principles may be included although two are shown, and hence more than two communication lanes may be established.

Without reference to any particular figure, it is to be understood that less lanes than transceiver pairs may be used at any given time even if more lanes are available between a host computer and docking station e.g. depending on bandwidth required or requested at any given time, and may even e.g. sequentially alternate which transceiver pairs are used when less than all available are pairs and hence lanes are to be used. For instance, if thirty two WiGig transceivers on a computer respectively establish thirty two lanes with respective WiGig transceivers on a docking station, but the bandwidth required at a given time for communication between the computer and docking station may be satisfied using four lanes, then it may be determined that only four lanes may meet the bandwidth requirement and hence are actually used. Also without reference to any particular figure, it is to be understood that e.g. two adjacent lanes that are established my transmit data in alternating bits, or may send the same bits for redundancy.

It may now be appreciated that present principles provide ample bandwidth for a computing system to complete workstation tasks in conjunction with a docking station. Resources such as graphics adapters and hard disk drives on a docking station may thus be utilized to their e.g. full capacity in conjunction with a host computer owing to ample bandwidth being provided by e.g. WiGig transceiver pairs as set forth above.

Furthermore, it is to be understood that dedicated millimeter wireless connections in accordance with present principles provide respective lanes of peripheral component interconnect express (PCIe) based on their connection thereto on either a host computer or docking station. Such millimeter wireless connections are also understood to have input/outputs of differential pairs, and thus may connect directly to chipsets for systems and peripheral components.

Furthermore, it is to be understood that by using a large number of millimeter wireless transceivers, a requested, relatively high bandwidth may nonetheless be provided. Alignment of the respective millimeter wireless transceivers on a host computer and on a docking station that establish a lane may be achieved within e.g. a margin of error of direct alignment of one to two millimeters, thus enabling ease of alignment by a user. Furthermore, since the spacing of adjacent millimeter wireless transceivers may be within e.g. one, two or three millimeters of each other while also transmitting signals that do not interfere with each other owing to orthogonal polarizations of signals being transmitted over adjacent lanes, an array of e.g. sixteen millimeter wireless transceivers may be placed e.g. at the bottom of a notebook in close proximity and be aligned with a complimentary array on a docking device.

What's more, present principles recognize that a workstation notebook may be constructed with different sizes and configurations of wireless millimeter transceiver arrays for different target audiences. For instance, a low-end workstation may support four lanes, while a high end workstation may support thirty two lanes.

Further still, present principles recognize that e.g. chips supporting repartitioning of lanes between one, two, or three adapters may be used to support various dock configurations. For example, a sixteen lane computer may connect to a dock that has four connectors for four video cards.

Thus, it may now be appreciated that wireless millimeter wave transceivers such as e.g. WiGig transceivers provide a solution to the (e.g. physical and/or mechanical) problems in reliability of current connectors and connections, as well as a solution to electro-magnetic interference (EMI) emission concerns existing with current systems. Furthermore, the low-power nature of millimeter wave transceivers provides a high bandwidth solution while not interfering with other wireless standards owing e.g. to the fact that they operate at high frequency with lower power over a relatively short distance, thus not causing much if any interference with other devices communicating over frequencies outside the millimeter wave bands. Millimeter wave transceivers in accordance with present principles also provide not just relatively high bandwidths but also may enhance the width of a channel or lane as well.

In addition to the foregoing, whereas wires that may be used to connect a docking station to a computer require near-perfect if not perfect alignment, millimeter wave transceivers in accordance with present principles provide a margin of alignment error while still providing ample if not abundant bandwidth for e.g. a notebook computer to complete task using a docking station it would not have the resources to efficiently complete in isolation.

Concluding the detailed description, it is to be understood that millimeter wave transceivers in accordance with present principles may be used in conjunction with many different kinds of buses, such as but not limited to PCT, USB, DP, and SATA buses. Thus, e.g., a single integrated wireless millimeter wave (e.g. WiGig) chip may include a radio and antenna, where such a chip may execute logic for signal transmission and operate its radio at the same time, and thus operating systems for the docking station and computer need not necessarily be privy to the fact that millimeter wave chips are being used since the data they receive (e.g. so-called “copper cable” plus and minus technology data) is still copper cable data since the millimeter wave chip in understood to have converted the data back to copper cable data after receiving a polarized millimeter wave signal in accordance with present principles. Put another way, copper data is converted by a wireless millimeter wave chip to a wireless millimeter wave standard and is then transmitted to a receiving wireless millimeter wave chip on a complimentary device in accordance with present principles, and the receiving chip may then convert the data back to copper cable data that is used in a PCIe bus, etc. But regardless, a positive-negative sequence of transceivers on a device (e.g. with a ninety degree orientation difference as set forth herein) prevents interference (e.g. “cross-talk”) between any two adjacent lanes of transceivers.

While the particular MILLIMETER WAVE WIRELESS COMMUNICATION BETWEEN COMPUTING SYSTEM AND DOCKING STATION is herein shown and described in detail, it is to be understood that the subject matter which is encompassed by the present application is limited only by the claims.

What is claimed is:

1. A system, comprising:
at least one computer;
at least one dock which engages the computer; and
at least first and second millimeter wave transceivers which transmit information between the computer and the dock, wherein the first transceiver sends signals having a first polarization and the second transceiver sends signals having a second polarization orthogonal to the first polarization.

2. The system of claim 1, wherein the first transceiver is on the dock and the second transceiver is on the computer.

3. The system of claim 1, wherein the first and second transceivers are on the dock.

4. The system of claim 3, wherein the first and second transceivers are oriented on the dock orthogonal to each other to at least in part to establish the respective first and second polarizations.

5. The system of claim 3, wherein respective antennas on the first and second transceivers are oriented orthogonal to each other to at least in part to establish the respective first and second polarizations.

6. The system of claim 1, wherein the first and second transceivers are on the computer.

7. The system of claim 1, comprising filters establishing the first and second polarizations.

8. The system of claim 1, comprising reflectors establishing the first and second polarizations.

9. The system of claim 1, comprising refractors establishing the first and second polarizations.

10. The system of claim 1, wherein the first and second millimeter wave transceivers send and receive signals in a band comprising at least twelve GHz to eighty six GHz.

11. The system of claim 10, wherein the first and second millimeter wave transceivers are wireless gigabit (WiGig) transceivers.

12. The system of claim 11, wherein respective antennas on the first and second transceivers are oriented orthogonal to each other to at least in part establish the respective first and second polarizations.

13. A method, comprising:
sending information from a computer to a docking station using a wireless 60 gHz transmitter; and
receiving the information at the docking station using a 60 gHz receiver.

14. The method of claim 13, comprising sending information from the docking station to the computer using a 60 gHz wireless frequency.

15. The method of claim 13, comprising sending information from the computer to the docking station using at least two wireless 60 gHz transmitters and receiving the information at the docking station using at least two wireless 60 gHz receivers, wherein a first of the at least two wireless 60 gHz transmitters sends signals with a first polarization and a second of the at least two wireless 60 gHz transmitters sends signals with a second polarization different from the first polarization.

16. The method of claim 15, wherein the first polarization is at least substantially orthogonal to the second polarization.

17. The method of claim 16, wherein the first and second transmitters are oriented orthogonal to each other to at least in part establish the first and second polarizations.

18. A system, comprising:
at least a first computing component which wirelessly communicates with at least a second computing component; and
at least first and second wireless gigabit (WiGig) transceivers which transmit information between the first and second components, wherein the first transceiver sends signals having a first polarization and the second transceiver sends signals having a second polarization orthogonal to the first polarization.

19. The system of claim 18, wherein the first computing component is a computer and the second computing component is a docking station which mechanically engages the computer.

20. The system of claim 18, wherein the first and second WiGig transceivers send and receive signals in the band of 57 GHz to 64 GHz.
